(19) United States
(12) Patent Application Publication
(10) Pub. No.: US 2007/0229998 A1
(43) Pub. Date: Oct. 4, 2007

(54) Master for magnetic transfer and method of producing vertical recording medium

(75) Inventors: Sumio Kuroda, Kawasaki (JP); Takeshi Morikawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/507,335

(22) Filed: Aug. 21, 2006

(30) Foreign Application Priority Data
Mar. 31, 2006 (JP) 2006-100878

(51) Int. Cl. G11B 5/66; G11B 5/86; B05D 5/12

(52) U.S. Cl. 360/15; 428/827; 428/826; 428/836; 360/16; 360/135; 427/127

(57) ABSTRACT

A master for magnetic transfer is made which comprises a substrate which has on a surface thereof a convex area and a concave area corresponding to servo information and which is constituted of a soft magnetic, and a ferromagnetic which is provided in the concave portion of the substrate, which has a coercive force larger than the external magnetic field for reversing the direction of magnetization of the vertical recording medium, and which has magnetization in a direction opposite to the direction of the external magnetic field.

### BACKGROUND OF THE INVENTION

1. Field of the Invention

The present invention relates to a method of producing a vertical recording medium in which prescribed information is magnetically transferred in a lump transfer from a master for a magnetic transfer to a vertical recording medium.

2. Description of the Related Art

The conventional method of producing a vertical recording medium in which prescribed information is magnetically transferred to a vertical recording medium in a lump transfer involves a method, for example, in which a vertical recording medium 213 is made to adhere to a master for magnetic transfer 212 comprising a Ni-substrate 210 having convex and concave surfaces corresponding to the prescribed information and soft magnetics 211 on the concavo-convex surface of the Ni-substrate 210. Next, the prescribed information is magnetically transferred to the recording medium 213 in a lump transfer by externally applying a magnetic field in a vertical direction to the recording surface of the vertical recording medium 213, as shown in FIG. 1 and FIG. 2 (e.g., Patent Document 1).

In order to realize efficient recording performance in the above method of producing the vertical recording medium, it is necessary that magnetic flux is converged to the soft magnetics 211 in the convex portions, and the magnetic fields in the vicinities of the surfaces of the soft magnetics 211 in the convex portions are sufficiently large.

However, in the master for magnetic transfer 212 shown in FIG. 1, demagnetization fields are generated in the direction opposite to the direction of the magnetic flux in the soft magnetics 211. Accordingly, it is impossible to obtain leakage flux (i.e., a large vertical magnetic field so as to contribute to the recording of the prescribed information in the vicinities of the surfaces of the soft magnetics 211) due to these demagnetization fields. Furthermore, in the master for magnetic transfer 212 as shown in. FIG. 1, the soft magnetics 211 are also provided on a concavo-convex wall of the Ni-substrate 210. As shown in FIG. 2, this results in the magnetic flux tending to concentrate on the edge portions of the convex portions of the Ni-substrate 210, which then causes the magnetic fields in the edge portions of the soft magnetics 211 in the convex portions to grow larger. Therefore, a reproduced waveform of the vertical recording medium 213, recording the prescribed information by using the master for magnetic transfer 212, is not a desirable rectangular waveform corresponding to the concavo-convex shape of the Ni-substrate 210 (see reproduced waveform 214 of FIG. 2).

In conditions such as those above, it is possible to cause the external magnetic field to be large enough in order to obtain a magnetic field in the vertical direction which is sufficiently large enough, at least so as to contribute to the recording of the prescribed information in the vicinities of the surfaces of the soft magnetics 211. However, when the external magnetic field is made larger, the area of the magnetic flux spreads to the concave portions of the Ni-substrate 210, and the positions of the magnetic walls of the vertical recording medium 213 (the boundary at which the magnetic fields internally distributed in the vertical recording medium 213 are reversed) do not correspond to the positions of the edge portions of the convex and concave surfaces of the Ni-substrate 210, such that the reproduced waveform of the vertical recording medium 213 is not the rectangular waveform corresponding to the concavo-convex shape of the Ni-substrate 210.

When the reproduced waveform of the vertical recording medium 213 is not the rectangular waveform corresponding to the concavo-convex shape of the Ni-substrate 210 as above, this could, for example, create a situation in which the accuracy of decoding address and servo information recorded in the vertical recording medium 213 deteriorates.

As a method of producing a vertical recording medium for solving the above problem, an example method in which a vertical recording medium 213 is made to adhere to a master for magnetic transfer 217, which includes a substrate 215 having on its surface convexes and concaves areas corresponding to the prescribed information as well as ferromagnetics 216 provided in the concave portions of the substrate 215. Next, the prescribed information is magnetically transferred to the recording medium 213 in a lump transfer by externally applying a magnetic field (as illustrated by the arrow in FIG. 4) in a horizontal direction with respect to the recording surface of the vertical recording medium 213, as illustrated in FIG. 4 (e.g., see the Patent Document 2).

As illustrated in FIG. 4, in the vertical recording medium produced by the above method, magnetic field intensity 218 as distributed in the vertical recording medium 213 is maximum at the edge portions of the ferromagnetics 216, and the magnetic field intensity 218 as distributed in the vertical recording medium 213 is nearly zero around the center portions of the ferromagnetics 216 and in the vicinity of the point halfway between the ferromagnetics 216. Thus, even when the external magnetic field varies, it is possible that the positions at which a reproduced waveform 219 of the vertical recording medium 213 are at their maximum corresponding to the positions of the edge portions of the concave convex areas of the substrate 215. Additionally, the above method of producing the vertical recording medium employs a configuration that applies the external magnetic field in a horizontal direction. Accordingly, the demagnetization fields generated in the ferromagnetics 216 do not affect the vertical recording medium 213.

It is possible to improve the reliability of a magnetic disk device because the quality of there produced waveform of the servo information may be improved by recording the servo information in the magnetic disk using the method of producing the vertical recording medium in which the external magnetic field is applied in the horizontal direction as described above.

### Patent Document 1

Japanese Patent Application Publication No. 10-40544

### Patent Document 2

Japanese Patent Application Publication No. 2001-297433

Recently, with the improvement and increases of track density of magnetic disks, for a technique for further improving the reproduction accuracy of the servo information has been developed. This technique, using eccentricity correction information to correlate an error of the servo information records the eccentricity correction information after first recording the servo information to the magnetic disk. However, because this eccentricity correction information is generally recorded by a magnetic head, the reproduced waveform of the magnetic disk in which the eccentricity correction information is recorded is the rectangular waveform as illustrated in FIG. 5. This necessitates a situation in which, when eccentricity correction information is recorded, the magnetic head records the servo information on the magnetic disk (by producing the vertical recording medium in which the external magnetic field is applied) in the horizontal direction, as above, in order to increase the track density of the magnetic disk while improving the quality of the reproduced servo information waveform. Accordingly, this create a complication in which two types of read channels, one for reading servo information and one for reading eccentricity correction information must be dealt with. This results in a configuration of the magnetic disk device becoming complicated in order to handle both types of read channels.

### SUMMARY OF THE INVENTION

It is an object of the present invention to provide a master for a magnetic transfer and a method of producing a vertical recording medium that can increase track density of the vertical recording medium while improving the quality of a reproduced waveform of information recorded in the vertical recording medium.

In order to attain the above object, the present invention employs the methods below.

In a method according to the present invention of producing the vertical recording medium, the direction of magnetization of the vertical recording medium is opposite to the direction of the external magnetic field applied to the vertical recording medium when prescribed information is magnetically transferred from the master for magnetic transfer to the vertical recording medium, and the vertical recording medium is caused to adhere to or caused to be adjacent to the master for magnetic transfer comprising a substrate having on its surface convex and concave areas corresponding to the prescribed information (at least the convex portions of which are constituted of soft magnetics), and ferromagnetics which are provided in the concave portions of the substrate, which has a coercive force larger than the above external magnetic field, and which has the magnetization in the direction opposite to that of the above external magnetic field, and then an external magnetic field larger than the coercive force of the vertical recording medium is applied to the vertical recording medium.

Therefore, it is possible that the direction of the magnetization of the portion which adheres to or which is adjacent to the ferromagnetics in the vertical recording medium is the same as the direction of the magnetization of the ferromagnetics (by the magnetization of the ferromagnetics), and the direction of the magnetization of the portion which does not adhere to or which is not adjacent to the ferromagnetics in the vertical recording medium is opposite to the direction of the magnetization of the ferromagnetics by the strength of the external magnetic field. As such, it is possible that a contrast of the magnetic fields distributed in the vertical recording medium corresponds to the concavo-convex surface shape of the master substrate for magnetic transfer; accordingly, it is possible that the reproduced waveform of the prescribed information which is magnetically transferred to the vertical recording medium is the rectangular waveform.

In the method of producing the vertical recording medium according to the present invention, the ferromagnetics are provided in the concave portions of the master substrate used for the magnetic transfer. Accordingly, the magnetic flux of the external magnetic field does not concentrate on the edge portions of the convex portions. Additionally, the direction of the magnetization of the portions which do not adhere to or which are not adjacent to the ferromagnetics in the vertical recording medium is reversed by the external magnetic field, accordingly, the demagnetization fields generated in the ferromagnetics do not affect the magnetic field distributed in the vertical recording medium. The coercive force of the ferromagnetics is larger than the strength of the external magnetic field, thus, even when the strength of the external magnetic field varies, the positions of the magnetic wall of the vertical recording medium do not shift from the positions at the edge portions of the convex portions of the master substrate for magnetic transfer. Accordingly, it is possible that the reproduced waveform of the vertical recording medium is the rectangular waveform corresponding to the concavo-convex surface of the master substrate for magnetic transfer, such that the quality of the reproduced waveform can be improved.

Additionally, using the method of producing the vertical recording medium according to the present invention, it is possible that the reproduction waveform of the prescribed information recorded in the vertical recording medium is the rectangular waveform, and it is possible to improve the track density of the vertical recording medium by recording the servo information in the vertical recording medium using the production method according to the present invention and thereafter recording the eccentricity correction information by the magnetic head in the vertical recording medium. It is also possible that the read channel is of one type in the magnetic head while reading the servo information and the eccentricity correction information, and thus, it is possible to avoid a complicated configuration of the magnetic disk device comprising the vertical recording medium.

In the method of producing the vertical recording medium according to the present invention, a configuration may be employed such that when the vertical recording medium is made to adhere to or to be adjacent to the master for magnetic transfer, two master substrates for magnetic transfer are respectively caused to adhere to or to be adjacent to upper and lower surfaces of the vertical recording medium.

Please note that the scope of the present invention includes:
the master for magnetic transfer used in the method of producing the vertical recording medium according to the present invention,
the vertical recording medium in which the magnetic transfer is conducted by the present production method, and
the magnetic disk device comprising the vertical recording medium in which the magnetic transfer is conducted by the present production method.

According to the present invention, it is possible to improve the track density of the vertical recording medium, while improving the quality of the reproduced waveform of the information recorded in the vertical recording medium.

### BRIEF DESCRIPTION OF THE DRAWINGS

FIG. 1 shows a conventional master for magnetic transfer;

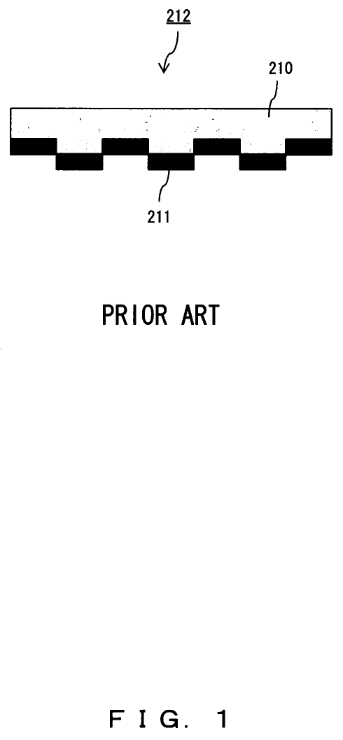

FIG. 2 shows flux generated when recording information to a vertical recording medium by the conventional master for magnetic transfer, and a reproduced waveform of the vertical recording medium;

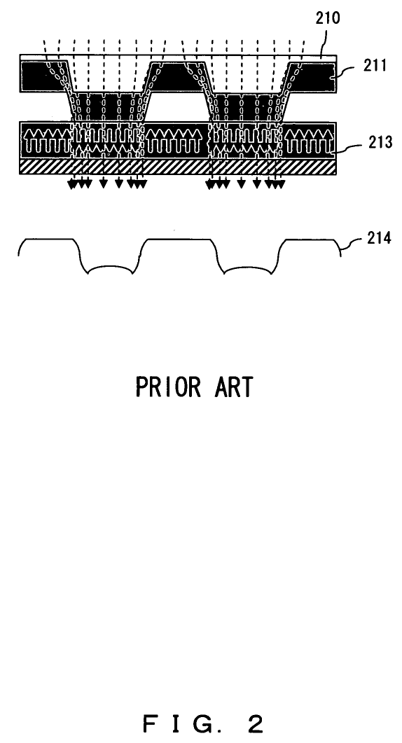

FIG. 3 shows flux when an external magnetic field is large when recording information to a vertical recording medium by the conventional master for magnetic transfer;

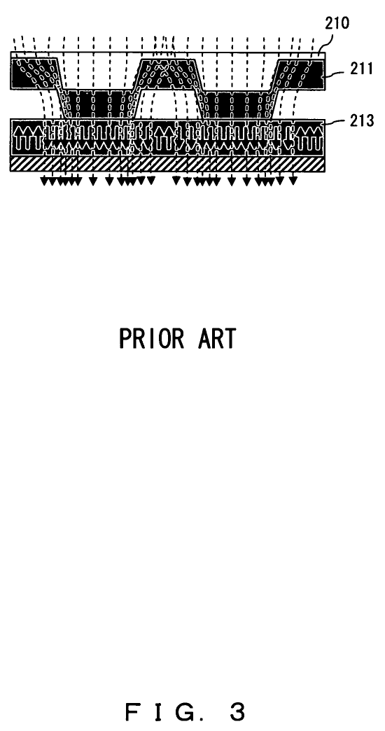

FIG. 4 shows a master for magnetic transfer used for a method of producing a conventional recording medium, and a reproduced waveform of the vertical recording medium in which information is recorded by the master for magnetic transfer;

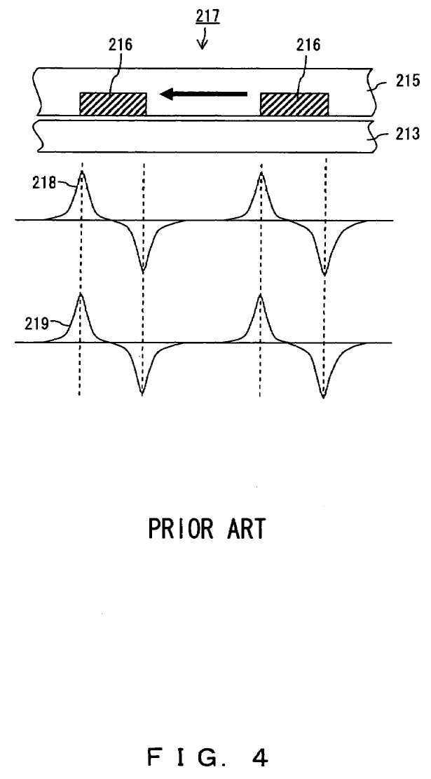

FIG. 5 shows a reproduced waveform of a magnetic disk in which information is recorded by a magnetic head;

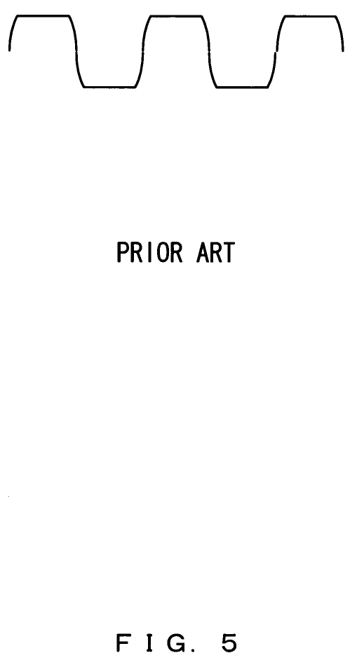

FIG. 6 shows a master for magnetic transfer according to an embodiment of the present invention;

FIG. 7 shows a flowchart of a method of producing a vertical recording medium according to the present embodiment;

FIG. 8 shows a direction of magnetization after initialization of the vertical recording medium;

FIG. 9 shows the magnetic transfer using the method of producing the vertical recording medium according to the present embodiment;

FIG. 10 shows directions of magnetization of the vertical recording medium after magnetic transfer, and a reproduced waveform of the information recorded in the vertical recording medium;

FIG. 11 shows RRO (Repeatable Run Out) of servo information when eccentricity correction information is not recorded in a vertical recording medium;

FIG. 12 shows RRO of servo information when eccentricity correction information is recorded in the vertical recording medium;

FIG. 13 is a view explaining the method of producing the vertical recording medium in the case in which servo information is recorded to both sides of the vertical recording medium in a lump transfer by a master for magnetic transfer (first);

FIG. 14 is a view explaining the method of producing the vertical recording medium in the case in which servo information is recorded to both sides of the vertical recording medium in a lump transfer by a master for magnetic transfer (second);

FIG. 15 is a view explaining the method of producing the vertical recording medium in the case in which servo information is recorded to both sides of the vertical recording medium in a lump transfer by a master for magnetic transfer (third);

FIG. 16 is a view explaining the method of producing the vertical recording medium in the case in which servo information is recorded to both sides of the vertical recording medium in a lump transfer by a master for magnetic transfer (fourth);

FIG. 17 shows a flowchart of the method of producing the master for magnetic transfer according to the embodiment of the present invention;

FIG. 18 shows an example of patterns of the servo information;

FIG. 19 shows another example of patterns of the servo information;

FIG. 20A is a view explaining the method of producing the master for magnetic transfer according to the embodiment of the present invention (first);

FIG. 20B is a view explaining the method of producing the master for magnetic transfer according to the embodiment of the present invention (second);

FIG. 20C is a view explaining the method of producing the master for magnetic transfer according to the embodiment of the present invention (third);

FIG. 20D is a view explaining the method of producing the master for magnetic transfer according to the embodiment of the present invention (fourth);

FIG. 20E is a view explaining the method of producing the master for magnetic transfer according to the embodiment of the present invention (fifth);

FIG. 20F is a view explaining the method of producing the master for magnetic transfer according to the embodiment of the present invention (sixth);

FIG. 21 shows a master for magnetic transfer according to another embodiment of the present invention;

FIG. 22 shows a flowchart of a method for producing a master for magnetic transfer according to another embodiment of the present invention;

FIG. 23 shows a flowchart of another method for producing a master for magnetic transfer according to another embodiment of the present invention;

FIG. 24 shows a master for magnetic transfer according to yet another embodiment of the present invention; and

FIG. 25 shows a flowchart of a method of producing a master for magnetic transfer according to still another embodiment of the present invention.

### DESCRIPTION OF THE PREFERRED EMBODIMENTS

Herein below, embodiments of the present invention will be explained, by reference to the drawings.

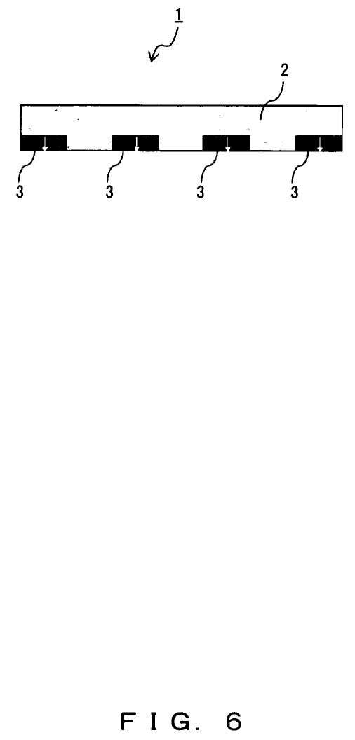

FIG. 6 shows a master for magnetic transfer according to an embodiment of the present invention.

A master for magnetic transfer 1 of FIG. 6 is constituted of a soft magnetic, and comprises a substrate 2 having on its surface convexes and concaves correspondent to servo information, and ferromagnetics 3 which are provided in the concave portions of the substrate 2 and which have the magnetization in the direction opposite to the direction of an external magnetic field when the servo information is magnetically transferred to the vertical recording medium. Arrows in FIG. 6 indicate the direction of the magnetization that the ferromagnetics possess.

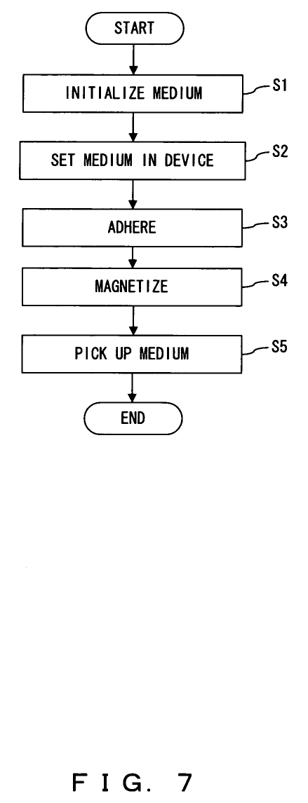

FIG. 7 is a flowchart of a method for producing the vertical recording medium using the master for magnetic transfer 1.

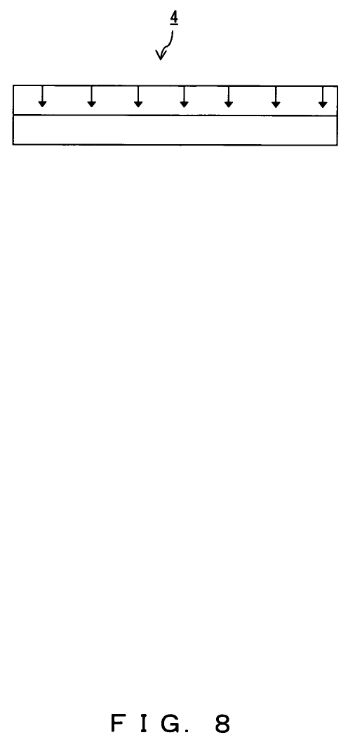

First, initialization is conducted such that the direction of the magnetization of the vertical recording medium is opposite to that of the external magnetic field when magnetically transferring the servo information to the vertical recording medium (by applying a magnetic field to the vertical recording medium) for example (step S1). The initialization is conducted such that the direction of the magnetization of a vertical recording medium 4 is the direction indicated by the arrows as shown in FIG. 8, for example.

Next, the vertical recording medium is set at a prescribed position of the external magnetic field application device including the master for magnetic transfer 1 (step S2).

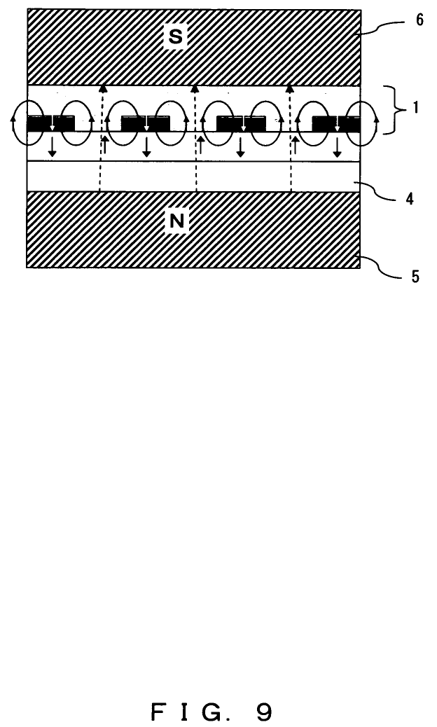

Next, the master for magnetic transfer 1 and the vertical recording medium are caused to adhere to each other such that the ferromagnetics 3 of the master for magnetic transfer 1 and the recording surface of the vertical recording medium 4 face each other (step S3). The master for magnetic transfer 1 and the vertical recording medium 4 are caused to adhere to each other as shown in FIG. 9, as an example. Additionally, it is also possible that the master for magnetic transfer 1 and the vertical recording medium 4 may be made adjacent to each other.

Next, the vertical recording medium is magnetized by applying, to the master for magnetic transfer 1 and the vertical recording medium, the external magnetic field in the direction opposite to that of the initialization with respect to the recording surface of the vertical recording medium (step S4). For example, as shown in FIG. 9, the external magnetic field in the direction (dashed arrows) opposite to the magnetization of the ferromagnetics 3 of the master for magnetic transfer 1 and the magnetization of the vertical recording medium 4 is applied to the master for magnetic transfer 1 and vertical recording medium 4 by an N-pole magnet 5 and an S-pole magnet 6 included in the above external magnetic field application device. The strength H of the external magnetic field is set such that Hcb<H<Hcm is satisfied where Hcb represents the coercive force of the vertical recording medium 4, and Hcm represents the coercive force of the ferromagnetic 3 of the master for magnetic transfer 1.

Then, the vertical recording medium is picked up from the external magnetic field application device, and the magnetic transfer of the servo information to the vertical recording medium terminates (step S5).

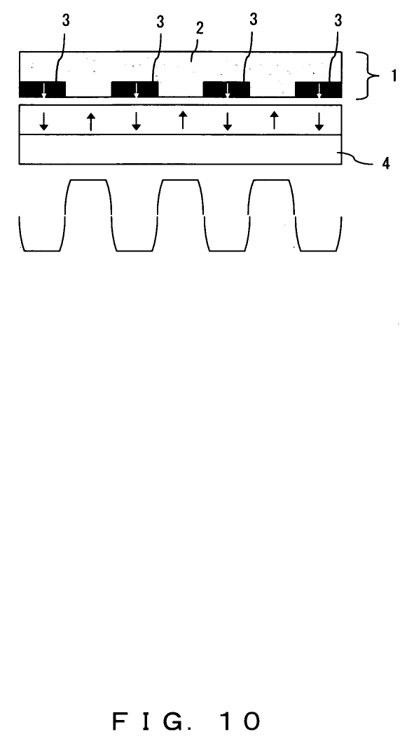

FIG. 10 shows the directions of the magnetization of the vertical recording medium after the termination of the magnetic transfer and the reproduced waveform of the information recorded in the vertical recording medium. The reproduced waveform of FIG. 10 is obtained by setting the vertical recording medium 4 in which the servo information is magnetically transferred using the method of producing the vertical recording medium according to the present embodiment in a spin stand and observing the waveform.

As shown in FIG. 10, in the vertical recording medium 4, the direction of the magnetization of the portions adhering to the ferromagnetics 3 is the same as the direction of the magnetization of the ferromagnetics 3 due to the magnetization of the ferromagnetics 3. Furthermore, in the vertical recording medium 4, the direction of the magnetization of the portions not adhering to the ferromagnetics 3 is opposite to the direction of the magnetization of the ferromagnetics 3 due to the strength H of the external magnetic field. As stated above, it is possible that the contrast of the magnetic fields distributed in the vertical recording medium 4 can correspond to the concavo-convex shape of the substrate 2 of the master for magnetic transfer 1, and accordingly it is possible that the reproduced waveform of the servo information which is magnetically transferred to the vertical recording medium 4 is the rectangular waveform as shown in FIG. 10.

In the method of producing the vertical recording medium according to the present embodiment, the ferromagnetics 3 are provided in the concave portions of the substrate 2 of the master for magnetic transfer 1. Accordingly, the magnetic flux of the external magnetic field does not concentrate on the edge portions of the convex portions of the substrate 2. Additionally, the direction of the magnetization of the portions in the vertical recording medium 4 not adhering to the ferromagnetics 3 is reversed by the external magnetic field; accordingly, the demagnetization fields generated in the ferromagnetics 3 do not affect the magnetic field distributed in the vertical recording medium 4. Furthermore, the coercive force of the ferromagnetic 3 Hcm is larger than the strength H of the external magnetic field; thus, even when the strength H of the external magnetic field varies, the positions of the magnetic wall of the vertical recording medium 4 do not shift from the positions of the edge portions of the convex portions of the substrate 2 of the master for magnetic transfer 1. Therefore, as shown in FIG. 10, it is possible that the reproduced waveform of the vertical recording medium 4 corresponds to the concavo-convex shape of the substrate 2 of the master for magnetic transfer 1, so that the quality of the reproduced waveform can be improved.

It is also possible that the reproduced waveform of the servo information recorded in the vertical recording medium 4 (using the method of producing the vertical recording medium according to the present embodiment) is the rectangular waveform. Accordingly, it is possible to increase the track density of the vertical recording medium 4 by recording the servo information in the vertical recording medium 4 using the production method according to the present embodiment and then recording eccentricity correction information in the vertical recording medium 4 using a magnetic head. It is also possible that a read channel may be of one type in the magnetic head when reading the servo information and the eccentricity correction information; therefore, avoiding a complicated configuration of the magnetic disk device (for example, a hard disk device), comprising the vertical recording medium 4, becomes possible.

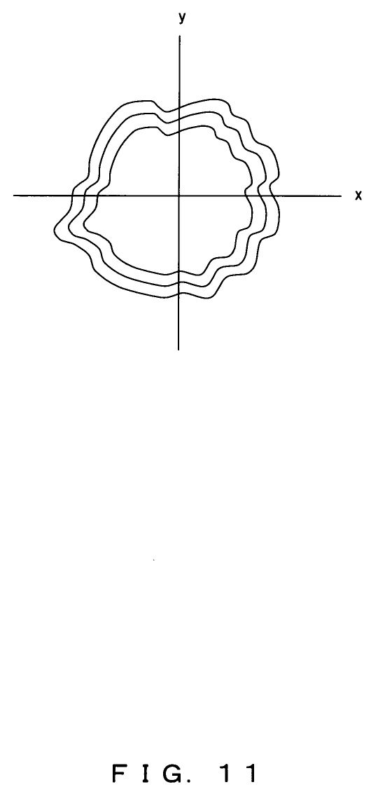

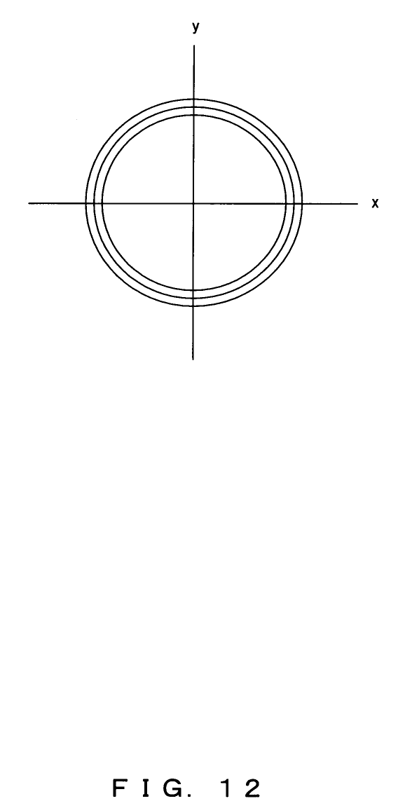

FIG. 11 shows RRO of servo information in the case in which the servo information is recorded in the vertical recording medium using the method of producing the vertical recording medium according to the present embodiment and when the eccentricity correction information is not recorded in the vertical recording medium. FIG. 12 shows RRO of the servo information when the eccentricity correction information is recorded in the vertical recording medium. In FIG. 11 and FIG. 12, the plane constituted by the x-axis and the y-axis corresponds to the plane of the vertical recording medium. A servo error signal is measured by averaging sixty-four cycles in order to eliminate NRRO (Non-Repeatable Run Out). Both of the RROs in FIG. 11 and FIG. 12 show loci of three cylinders. The eccentricity correction information is recorded in the last portion of a servo sector of the vertical recording medium after being encoded and the eccentricity correction information in the respective tracks may be created such that one instance of eccentricity correction information may be similar to the eccentricity correction information in the previous track or may be created independently.

When the eccentricity correction information is not recorded in the vertical recording medium, the RRO is very large as shown in FIG. 11, which creates a problem in increasing the density of the track of the vertical recording medium.

When the eccentricity correction information is recorded in the vertical recording medium as shown in FIG. 12, the RRO is smaller than the locus shown in FIG. 11 because the high order deflection is removed. In actuality, the error between adjacent tracks when the eccentricity correction information is not recorded is 15 nm, while the error between adjacent tracks when the eccentricity correction information is recorded is 8 nm. In other words, it is possible to almost double the track density of the vertical recording medium.

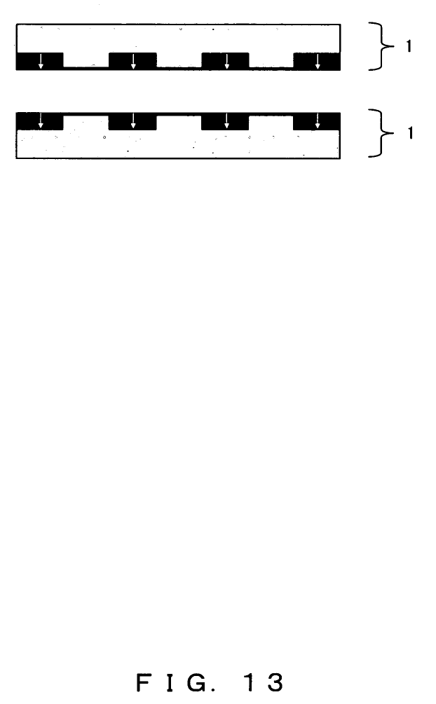

The following paragraphs explain the method of producing the vertical recording medium in the case in which the servo information is recorded on both sides of the vertical recording medium in a lump by the master for magnetic transfer 1 is explained by referring to FIG. 13 through FIG. 16:

First, a pair of the masters for magnetic transfer 1, respectively for the upper surface and the lower surface, are prepared as shown in FIG. 13. It is assumed that the servo information is magnetically transferred to the upper surface of the vertical recording medium by one master for magnetic transfer 1, and different servo information is magnetically transferred to the lower surface of the vertical recording medium by the other master for magnetic transfer 1. It is further assumed that initialization is conducted such that the direction (see diagrammatic arrows) of the magnetization of the respective ferromagnetics 3 in the respective masters for magnetic transfer 1 is opposite to the direction of the external magnetic field when the magnetic transfer of the servo information to the vertical recording medium is in the state such that the respective ferromagnetics 3 in the respective masters for magnetic transfer 1 face each other. Also, it is assumed that the coercive forces of the respective ferromagnetics 3 in the respective masters for magnetic transfer 1 are 8 kOe for example.

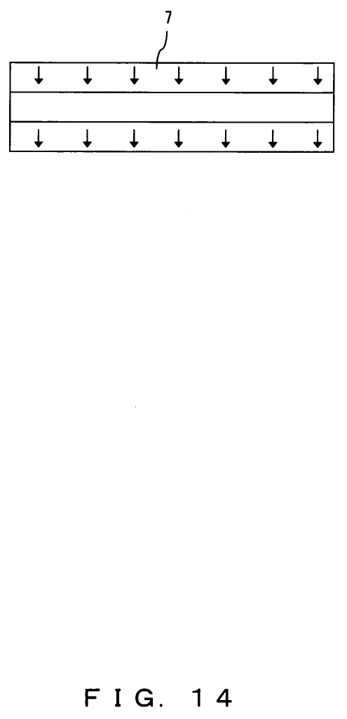

Next, as shown in FIG. 14, initialization is conducted such that the direction of the magnetization in both of the surfaces of a vertical recording medium 7 is vertical with respect to the recording surface of the vertical recording medium 7 by applying, for example, the electric field which is vertical with respect to the recording surface of the vertical recording medium 7. It is assumed that initialization is conducted such that the direction of the magnetization of the respective surfaces of the vertical recording medium 7 is opposite to the external field when the servo information is magnetically transferred to the vertical recording medium 7. It is further assumed that the strength of the magnetic field at the time of this initialization is 10 kOe, and the coercive force of each of the surfaces of the vertical recording medium 7 is 4 kOe.

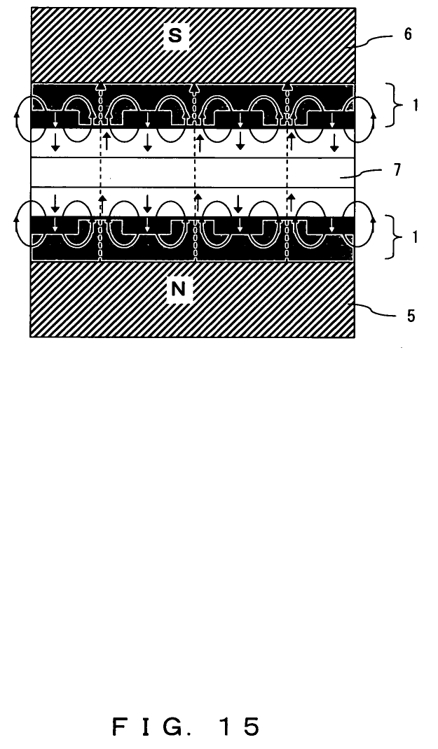

Following that, as shown in FIG. 15, the respective masters for magnetic transfer 1 are made to adhere to the vertical recording medium 7 in such a manner that the respective ferromagnetics 3 of the respective masters for magnetic transfer 1 face the respective recording surfaces of the vertical recording medium 7. Additionally, as stated above, it is also possible that the respective masters for magnetic transfer 1 are made to be adjacent to the vertical recording medium 7.

Furthermore, as shown in FIG. 15, the external magnetic field, vertical with respect to the recording medium of the vertical recording medium 7, is applied to the masters for magnetic transfer 1 and the vertical recording medium 7. Moreover, upon the above application, the strength H of the external magnetic field is set such that 4 kOe<H<8 kOe is satisfied, for example.

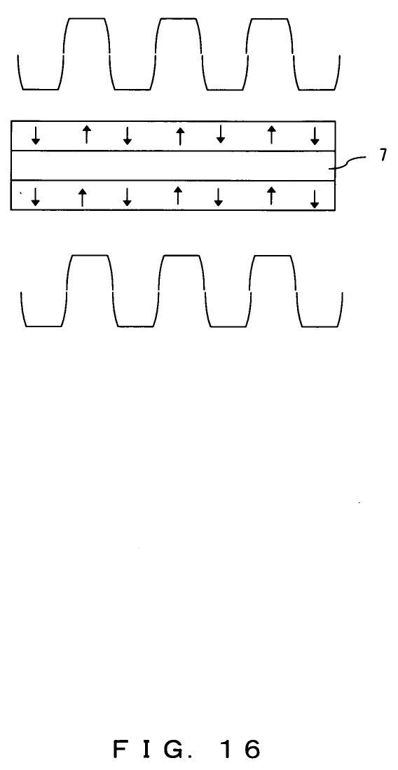

Then the reproduced waveforms of the servo information recorded on both surfaces of the vertical recording medium 7 are respectively rectangular waveforms as shown in FIG. 16.

In the case that one and the same servo information is recorded in both of the surfaces of the vertical recording medium 7, the convexes of one substrate 2 correspond to the concaves of the other substrate 2, and the concaves of the one substrate 2 correspond to the convexes of the other substrate 2 between the masters for magnetic transfer 1. Therefore, it is possible to read the respective servo information recorded in both of the surfaces of the vertical recording medium 7 with the same polarity.

The following describes a method of producing the master for magnetic transfer 1 is explained.

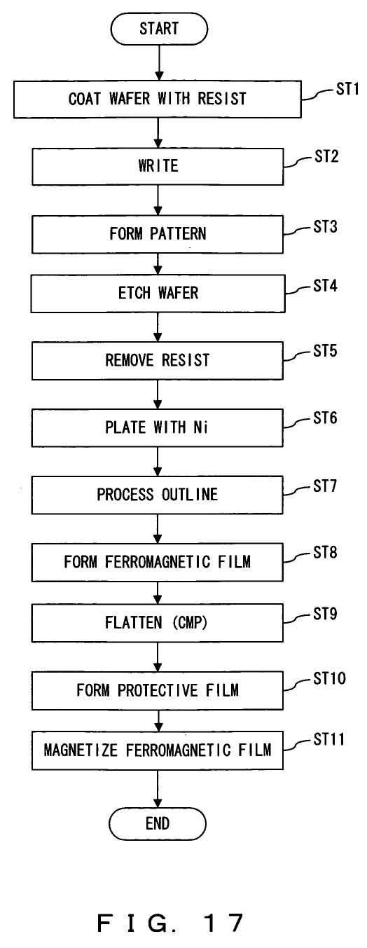

FIG. 17 is a flowchart of the method of producing the master for magnetic transfer 1. The method of producing the master for magnetic transfer 1 in this flowchart is the same as a method of producing a sputter of an optical disk, for example.

First, an Si wafer is coated with an electron beam resist (step ST1).

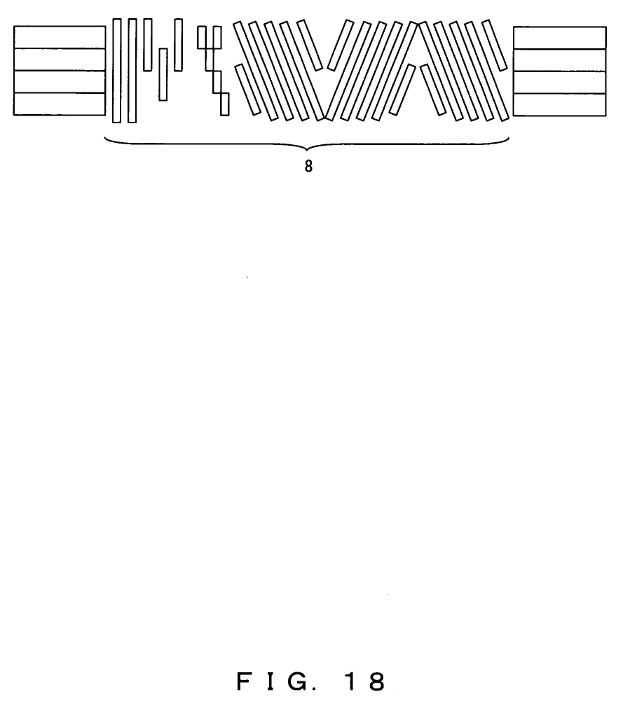

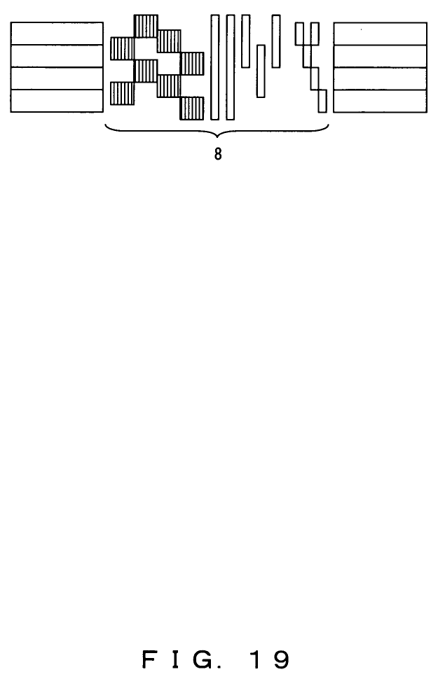

Second, patterns corresponding to the servo information are written by an electron beam writing system or the like (step ST2). For example, patterns corresponding to servo information 8 as shown in FIG. 18 and FIG. 19 are written.

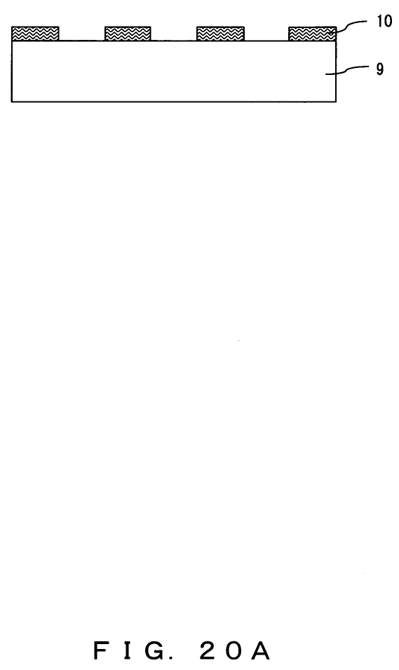

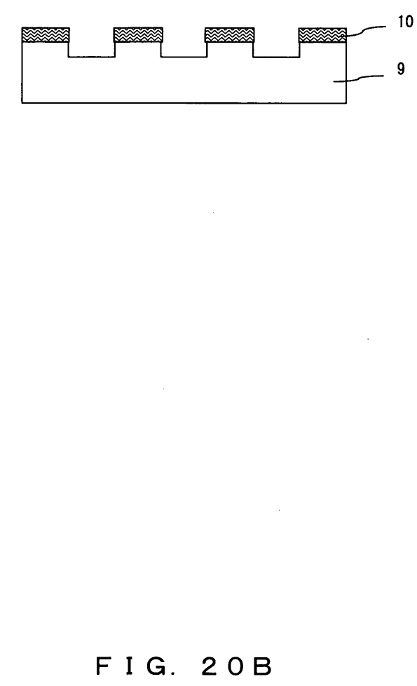

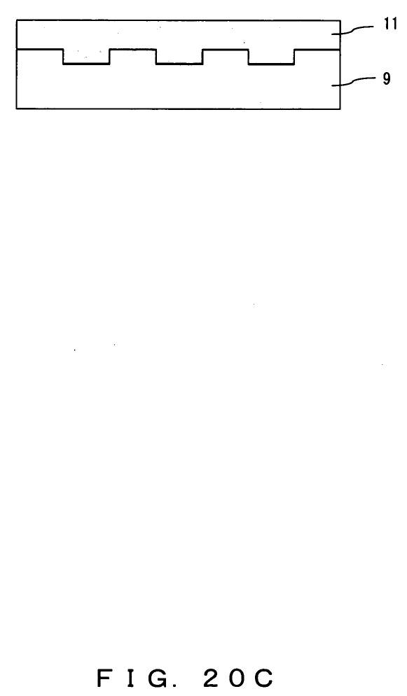

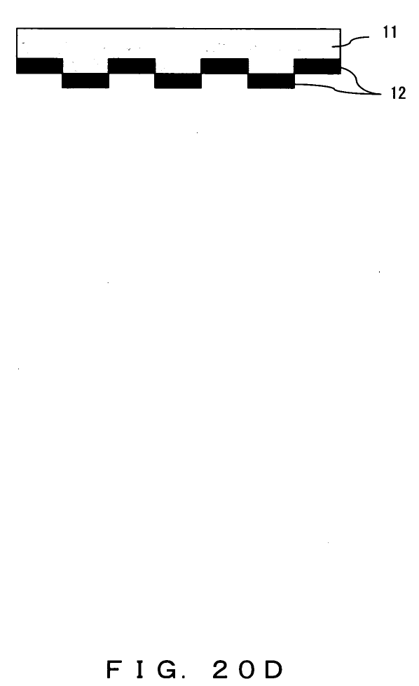

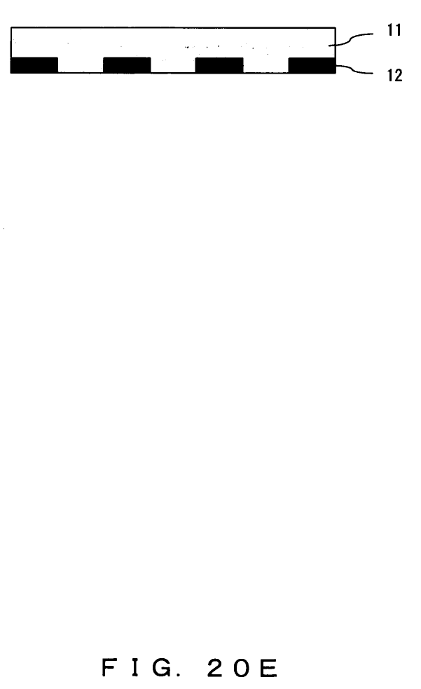

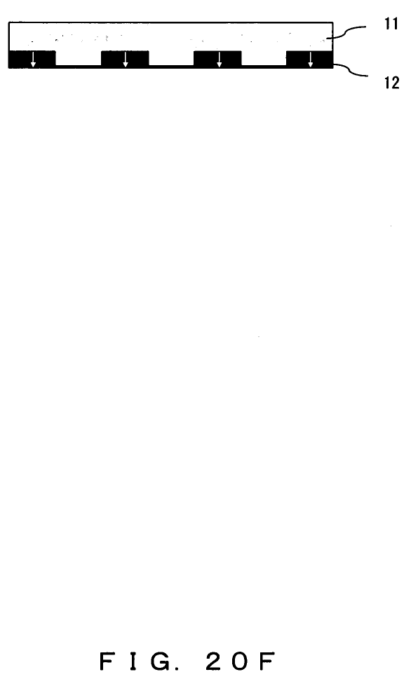

Third, in order to form patterns correspondent to the servo information, electron beam resists other than the resists of the corresponding patterns are removed (step ST3). Thereby, a resist 10 of patterns corresponding to the servo information, as shown in FIG. 20A is formed on a wafer 9.

Next, the wafer is etched (step ST4). The wafer may be etched to the depth of 100 nm by conducting an RIE (Reactive Ion Etching) for sixty seconds under the circumstance of SF6 of (Sulphur Hexafluoride gas) 1 Pa, 15 cc/min for example. Thus, as shown in FIG. 20B, the convexes and concaves correspondent to the servo information are formed on the wafer 9.

Following that, ashing is conducted on the wafer to remove the electron resist (step ST5). For example, the ashing is conducted for three minutes under the circumstance of oxygen of 10 Pa, 100 cc/min, for example.

Next, after a Ni electrode layer is formed on the convex and concave areas of the wafer by sputtering, the electrode layer is plated with Ni by an electroplating (step ST6). As an example, the electrode layer is plated with Ni of 300 um. Thereby, the convexes and concaves of the wafer 9 are plated with Ni 11 as shown in FIG. 20C. This Ni 11 serves as the substrate 2 of the master for magnetic transfer 1.

Furthermore, after the wafer is released from the Ni, the Ni is processed into a prescribed size by an outline processing device (step ST7). For example, the Ni with which the Si wafer whose diameter is 8 inches is plated is processed into the Ni whose diameter is 2.5 inches.

A ferromagnetic film is then formed by sputtering on the surface which had the Ni wafer, i.e., the convexes and concaves of the Ni (step ST8). The ferromagnetic film is TbFeCo (rare earth transition metal amorphous alloy), for example. Subsequently, ferromagnetic films 12 are formed on the convexes and concaves of the Ni 11 as shown in FIG. 20D. These ferromagnetic films 12 serve as the ferromagnetics 3 of the master for magnetic transfer 1.

Then, the ferromagnetic films are flattened by polishing the ferromagnetic films including the surface of the adjacent Ni (step ST9). For example, the ferromagnetic films are polished by CMP (Chemical Mechanical Planarization). Thereby, the Ni 11 and the ferromagnetic films 12 are flattened, as shown in FIG. 20E.

After that, protective films are formed on the flattened Ni and ferromagnetic films (step ST10). For example, the protective film of YSiO2 which is 2 nm in thickness is formed.

Hence, the ferromagnetic films are magnetized such that the direction of the magnetization of the ferromagnetic films is opposite to the direction of the external magnetic field applied to the vertical recording medium when the servo information is magnetically transferred to the vertical recording medium (step ST11). For example, the ferromagnetic films 12 are magnetized as shown in FIG. 20F. Also, the ferromagnetic films are magnetized in a state that the coercive forces of the ferromagnetic films are lowered under the circumstance of 10° C. Also, it is possible that the ferromagnetic films are magnetized with the magnetic field strength raised sufficiently and without heating.

In the following paragraphs, the master for magnetic transfer according to other embodiments of the present invention will be explained.

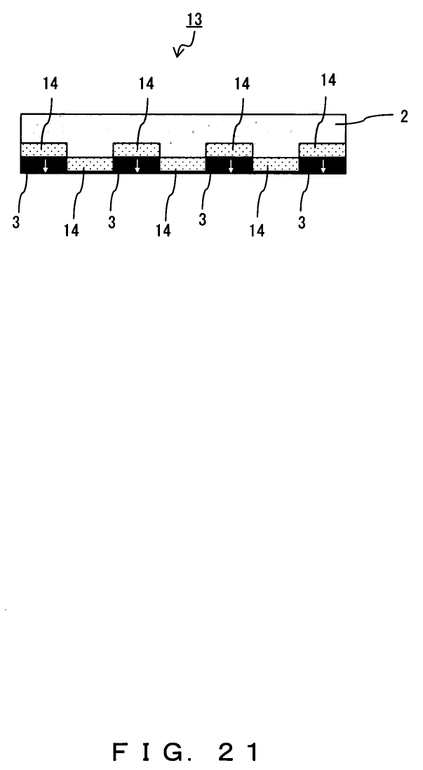

FIG. 21 shows the master for magnetic transfer according to other embodiments of the present invention. It is noted that like constituents are denoted by like symbols between FIG. 21 and FIG. 6.

A master for magnetic transfer 13 shown in FIG. 21 comprises the substrate 2, the ferromagnetics 3, and soft magnetics 14 which are provided between the substrate 2 and the ferromagnetics 3, and between the ferromagnetics 3 which have a magnetic permeability higher than that of the substrate 2. Additionally, by the method of producing the vertical recording medium using this master for magnetic transfer 13, it is possible to improve the track density of the vertical recording medium, while improving the quality of the reproduced waveform of the servo information recorded in the vertical recording medium, similarly to the above method of producing the vertical recording medium.

Also, in the method of producing the vertical recording medium using this master for magnetic transfer 13, the soft magnetics 14 are provided between the substrate 2 and the ferromagnetics 3 and between the substrate 2, accordingly, the master for magnetic transfer 13 does not tend to saturate even when the external magnetic field when magnetically transferring the servo information to the vertical recording medium is made larger, such that the contrast of the magnetic fields distributed in the vertical recording medium can be larger, which makes it possible to further improve the quality of the reproduced waveform.

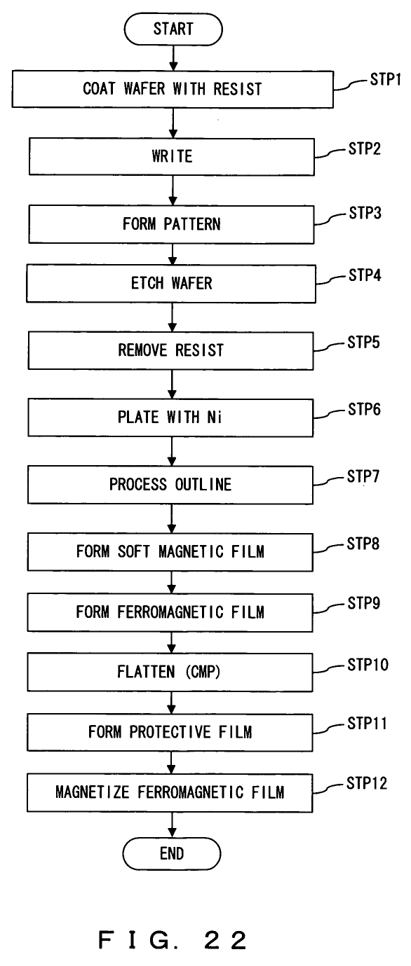

FIG. 22 is a flowchart showing the reproduction method of the master for magnetic transfer 13. It is to be noted that the steps through the step of outline process on the Ni (step STP7) are the same as the steps through the step of outline process on the Ni (step ST7) in the flowchart of FIG. 17, accordingly, the explanation thereof is omitted.

Next, sputtering is conducted to form soft magnetic films on the convexes and concaves of the Ni (step STP8). For example, sputtering is conducted for 180 seconds under the circumstance of Ar gas of 2 Pa, and FeCo which is 100 nm in thickness is formed. These soft magnetic films serve as the soft magnetics 14 of the master for magnetic transfer 13.

Sputtering is then conducted to form ferromagnetic films on the soft magnetic films (step STP9). For example, sputtering is conducted for 90 seconds under the circumstance of Ar gas of 2 Pa, and TbFeCo which is 100 nm in thickness is formed.

After that, the ferromagnetic films are flattened by polishing the ferromagnetic films including the surface of the adjacent soft magnetic film (step STP10). For example, the ferromagnetic films are polished by CMP.

Following that, protective films are formed on the flattened soft magnetic films and ferromagnetic films (step STP11). For example, the protective film of SiN which is 2 nm in thickness is formed.

Then, the ferromagnetic films are magnetized (step STP12) For example, a magnetic field of 20 kOe is applied by VSM (Vibrating Sample Magnetometer) for polarizing the ferromagnetic films.

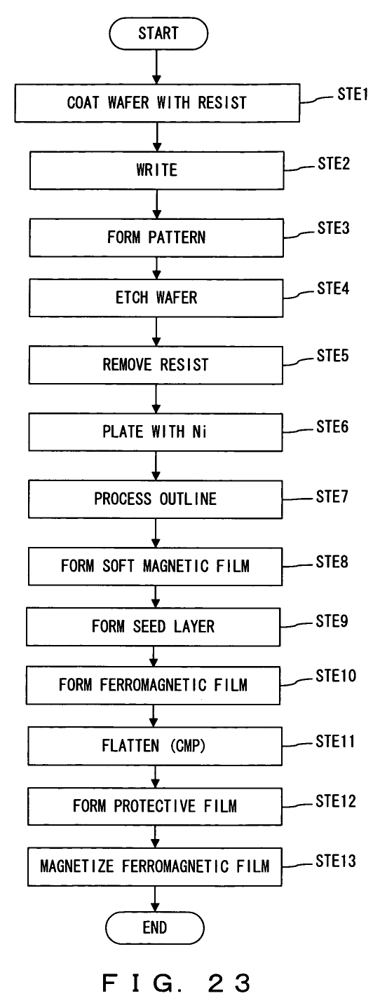

FIG. 23 is a flowchart of another method of producing the master for magnetic transfer 13. It is to be noted that the steps up to and including the step in which forming the soft magnetic films occurs (step STE8) are the same as the steps up to and including the step of forming the soft magnetic films (step STP8) in the flowchart of FIG. 22. Accordingly, the explanation thereof is omitted.

In this method, seed layers are formed on the soft magnetic films by sputtering as under layers of the ferromagnetic films (step STE9). Using this seed layer, it is possible that the flatness of the surface of the master for magnetic transfer 13 is improved, and the coercive force of the ferromagnetic films is improved. The seed layers of Ru which is 75 nm in thickness is formed on the soft magnetic films by DC magnetron sputtering under the circumstance of Ar gas of 3 Pa, for example.

Next, the ferromagnetic films are formed on the seed layers by sputtering (step STE10). The CoCrPt-SiO2 which is 15 nm in thickness is formed on the seed layers by RF magnetron sputtering under the circumstance of Ar gas of 2 Pa, for example.

Then the ferromagnetic films are flattened by polishing the ferromagnetic films, including the surface of the soft magnetic film (step STE11). For example, the ferromagnetic films are polished by CMP.

After that, protective films are formed on the flattened soft magnetic films and ferromagnetic films (step STE12), and the ferromagnetic films are magnetized (step STE13). For example, the ferromagnetic films are magnetized by VSM.

Following that, the master for magnetic transfer according to still another embodiment of the present invention will be explained.

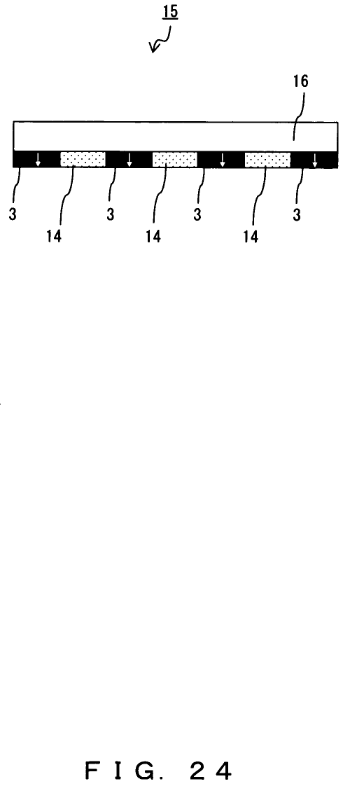

FIG. 24 shows the master for magnetic transfer according to yet another embodiment of the present invention. It is noted that like constituents are denoted by like symbols between FIG. 24 and FIG. 21.

A master for magnetic transfer 15 shown in FIG. 24 comprises a substrate 16 made of polycarbonate (PC), soft magnetics 14 which constitute convex portions among the convex and concave areas corresponding to the servo information, and the ferromagnetics 3. Furthermore, using the method of producing the vertical recording medium using this master for magnetic transfer 15, it is possible to increase the track density of the vertical recording medium while improving the quality of the reproduced waveform of the servo information recorded in the vertical recording medium, similarly to the above method of producing the vertical recording medium. In addition, the substrate 16 may be made of resin other than polycarbonate.

Because the substrate 16 is made of polycarbonate (in the method of producing the vertical recording medium using the master for magnetic transfer 15), adhesion with the vertical recording medium is improved when the servo information is magnetically transferred to the vertical recording medium. The contrast of the magnetic fields distributed in the vertical recording medium can be improved and the quality of the reproduced waveform can be further improved.

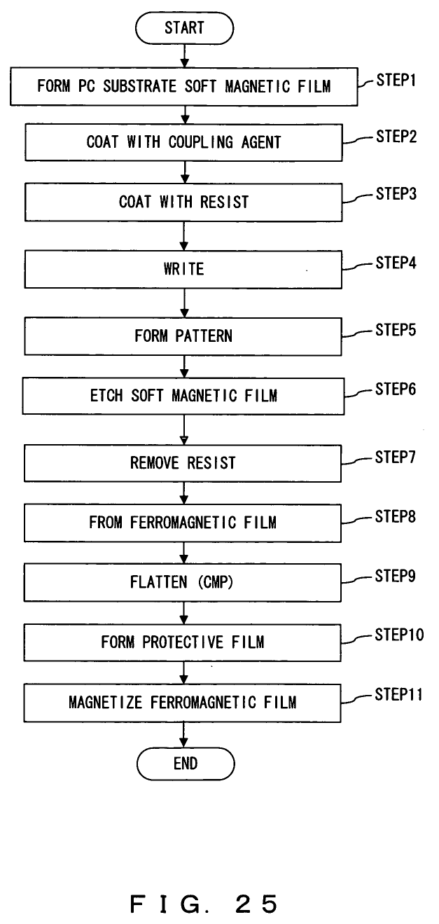

FIG. 25 is a flowchart showing the method of producing the master for magnetic transfer 15.

First, the soft magnetic films are formed on the substrate 16 whose surface is flattened (step STEP1). For example, the soft magnetic films are FeCo. These soft magnetic films serve as the soft magnetics 14 of the master for magnetic transfer 15.

Second, the soft magnetic films are coated with a coupling agent (step STEP2).

Third, the coupling agent is coated with an electron beam resist (step STEP3).

Fourth, patterns correspondent to the servo information are written on the electron beam resist by the electron beam writing system or the like (step STEP4).

Fifth, in order to form the patterns correspondent to the servo information, the electron beam resists other than the resists of the corresponding patterns are removed (step STEP5) Sixth, the soft magnetic films are etched (step STEP6). For example, the soft magnetic films are etched under the circumstance of Ar gas.

Seventh, the electron beam resists on the soft magnetic films are removed (step STEP7).

Eighth, the ferromagnetic films are formed by sputtering (step STEP8). The ferromagnetic films of DyFeCo (rare earth transition metal amorphous alloy) that are 100 nm in thickness may be formed, as an example.

Ninth, the ferromagnetic films are flattened by polishing the ferromagnetic films including the surface of the adjacent soft magnetic film (step STEP9). For example, the ferromagnetic films are polished by CMP.

Tenth, the protective films are formed on the flattened soft magnetic films and ferromagnetic films (step STEP10). For example, the SiN protective film which is 2 nm is thickness is formed.

Following that, the ferromagnetic films are magnetized (step STEP11). For example, the ferromagnetic films are magnetized by VSM.

Additionally, in the above embodiments, the servo information is magnetically transferred to the vertical recording medium. However, prescribed information that is not the servo information (e.g., audio information, image information, or the like) may be magnetically transferred to the vertical recording medium.

Also, in the above embodiments, the external magnetic fields, when magnetically transferring the prescribe information to the vertical recording medium, are generated by the N-pole magnet 5 and the S-pole magnet 6. However, the external magnetic fields when magnetically transferring the prescribed information to the vertical recording medium may be generated by electromagnets.

Furthermore, in the above embodiments, the convex and concave areas corresponding to the servo information are formed on the substrate using the electron beam resist. However, the convex and concave areas corresponding to the servo information may be formed on the substrate by means of a laser, an electron beam, an ion beam, machine processing or the like.

The methods of forming the above soft magnetic films and the above ferromagnetic films are not limited to the sputtering, such that a vacuum vapor deposition method, an ion plating method, a CVD (Chemical Vapor Deposition) method and the like maybe used. Nor is the material of the substrate 2 of the master for magnetic transfer 1 is not limited to glass, Al, or Ni.

What is claimed is:

1. A master for magnetic transfer in which prescribed information is magnetically transferred to a vertical recording medium, comprising:
a substrate which has on its surface convex and concave areas corresponding to the prescribed information, and in which at least the convex portion among the convex and the concave areas is constituted of soft magnetic; and
a ferromagnetic which is provided in the concave portion of the substrate, which has a coercive force larger than an external magnetic field for reversing a direction of magnetization of the vertical recording medium, and which has magnetization in a direction opposite to the direction of the external magnetic field.

2. The master for magnetic transfer according to claim 1, wherein:
the soft magnetic constituting the convex portion of the substrate has magnetic permeability higher than that of the soft magnetic constituting a portion other than the convex portion of the substrate.

3. The master for magnetic transfer according to claim 1, wherein:
the portion other than the convex portion of the substrate is constituted of resin.

4. The master for magnetic transfer according to claim 1, wherein:
a seed layer is provided between the substrate and the ferromagnetic.

5. The master for magnetic transfer according to claim 1, wherein:
the ferromagnetic is a rare earth transition metal amorphous alloy.

6. The master for magnetic transfer according to claim 1, wherein:
when two masters for magnetic transfer are used for realizing magnetic transfer of the prescribed information respectively to both surfaces of the vertical recording medium, convex and concave areas are formed such that the convex area of one substrate corresponds to the concave area of the other substrate, and the concave area of the one substrate corresponds to the convex area of the other substrate between the masters for magnetic transfer.

7. A method of producing a vertical recording medium comprising a step of magnetically transferring prescribed information from a master for magnetic transfer to the vertical recording medium, wherein:
the step of magnetic transfer comprises:
causing the direction of magnetization of the vertical recording medium to be opposite to the direction of an external magnetic field;
causing the vertical recording medium to adhere to or to be adjacent to the master for magnetic transfer comprising a substrate which has on a surface thereof a convex area and a concave area corresponding to the prescribed information and in which at least the convex portion among the convex area and the concave area is constituted of soft magnetic, and a ferromagnetic which is provided in the concave portion of the substrate, which has a coercive force larger than the external magnetic field, and which has magnetization in a direction opposite to a direction of the external magnetic field; and
applying, to the vertical recording medium, the external magnetic field larger than the coercive force of the vertical recording medium.

8. The method of producing a vertical recording medium according to claim 7, wherein:
when the vertical recording medium is caused to adhere to or to be adjacent to the master for magnetic transfer, the two masters for magnetic transfer are respectively caused to adhere to or to be adjacent to an upper surface and a lower surface of the vertical recording medium.

9. A magnetic disc device, comprising:
the vertical recording medium produced by the method of claim 7.
